(19) United States
(12) Patent Application Publication
(10) Pub. No.: US 2026/0281843 A1
(43) Pub. Date: Sep. 17, 2026

(54) METHOD AND APPARATUS FOR PERFORMING LTM COORDINATION IN DUAL CONNECTIVITY

(71) Applicant: Samsung Electronics Co., Ltd., Suwon-si, Gyeonggi-do (KR)

(72) Inventors: Aby Kanneath ABRAHAM, Bangalore (IN); Seungri JIN, Suwon-si (KR)

(21) Appl. No.: 19/166,686

(22) PCT Filed: Mar. 21, 2024
(86) PCT No.: PCT/KR2024/095613

§ 371 Date: Sep. 18, 2025

(30) Foreign Application Priority Data
Mar. 21, 2023 (IN) 202341019176
Mar. 6, 2024 (IN) 2023 41019176

(51) Int. Cl. H04W 36/00

(52) U.S. Cl. CPC H04W 36/0085; H04W 36/0069

(57) ABSTRACT

The disclosure relates to a 5G or 6G communication system for supporting a higher data transmission rate. The present disclosure relates to a method of performing lower Layer (L1/L2 layers) Triggered Mobility (LTM) coordination in dual connectivity is disclosed. The method comprises a master node (MN) determining frequency information to be used by a Secondary Node (SN) for the terminal for LTM and L3 mobility. Further, the method comprises transmitting an inter node message comprising frequency information to the SN. Furthermore, the method comprises receiving at least one of configuration information associated with LTM measurements and LTM candidate cells, configured by SN for the terminal based on the inter node message. Further, the method comprises determining measurement gaps and LTM candidate cell configuration for the terminal. Thereafter, the method comprises transmitting the measurement gaps and LTM candidate cell configuration to the SN and the terminal.

### TECHNICAL FIELD

The present disclosure relates to the field of wireless communication. More particularly, the present disclosure relates to a method and system for performing lower Layers (L1/L2 layers) Triggered Mobility (LTM) coordination in dual connectivity.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

Currently, there are needs to enhance performing LTM coordination in dual connectivity in a wireless communication system.

### Solution to Problem

The foregoing summary is illustrative only and is not intended to be in any way limiting. In addition to the illustrative aspects, embodiments, and features described above, further aspects, embodiments, and features will become apparent by reference to the drawings and the following detailed description.

In an embodiment, a method of performing lower Layer (L1/L2 layers) Triggered Mobility (LTM) coordination in dual connectivity is disclosed. The method comprises determining frequency information to be used by a Secondary Node (SN) for the UE for LTM and L3 mobility. Further, the method comprises transmitting an inter node message comprising the frequency information to the SN. Furthermore, the method comprises receiving at least one of configuration information associated with LTM measurements and LTM candidate cells, configured by SN for the UE based on the inter node message. Further, the method comprises determining measurement gaps and LTM candidate cell configuration for the UE, based on at least one of the configuration information of the LTM measurement and the LTM candidate cell received from the SN (104). Thereafter, the method comprises transmitting the measurement gaps and LTM candidate cell configuration to the SN and the UE.

In an embodiment, a master node for performing lower Layer (L1/L2 layers) Triggered Mobility (LTM) coordination in dual connectivity is disclosed. The master node comprises one or more processors and a memory. The memory stores processor-executable instructions, which, on execution causes the one or more processor to determine frequency information to be used by a Secondary Node (SN) for the UE for LTM and L3 mobility. Further, the one or more processors are configured to transmit an inter node message comprising maximum number of serving frequencies to be configured by SN for the UE and the number of frequencies configured by the MN to the SN. Furthermore, the one or more processors are configured receive at least one configuration information associated with LTM measurements and LTM candidate cells, configured by SN for the UE based on the inter node message. Further, the one or more processors are configured to determine measurement gaps and LTM candidate cell configuration for the UE, based on at least one of the configuration information of the LTM measurement and the LTM candidate cell received from the SN (104).

Thereafter, the one or more processors are configured to transmit the measurement gaps and the LTM candidate cell configuration to the SN and the UE.

In an embodiment, a method of performing lower Layer (L1/L2 layers) Triggered Mobility (LTM) coordination in dual connectivity is disclosed. The method comprises receiving an inter node message comprising frequency to be used by the SN for the UE for LTM and L3 mobility, from the Master node (MN) associated with the UE. Further, the method comprises determining at least one configuration information associated with LTM measurements and LTM candidate cells based on the inter node message. Furthermore, the method comprises transmitting the at least one configuration information associated with LTM measurements and LTM candidate cells to the MN. Thereafter, the method comprises receiving, by the SN, measurement gaps and LTM candidate cell configuration for the UE from the MN.

In an embodiment, a secondary node for performing lower Layer (L1/L2 layers) Triggered Mobility (LTM) coordination in dual connectivity is disclosed. The secondary node comprises one or more processors and a memory. The memory stores processor-executable instructions, which, on execution causes the one or more processor to receive an inter node message comprising frequency information to be used by SN for the UE, from the MN. Further, the one or more processors are configured to determine at least one of, configuration information associated with LTM and LTM candidate cells based on the inter node message. Furthermore, the one or more processors are configured to transmit at least one of, the configuration information associated with LTM measurements and LTM candidate cells to the MN, based on at least one of the configuration information of the LTM measurement and the LTM candidate cell received from the SN (104). Thereafter, the one or more processors are configured to receive measurement gaps and LTM candidate cell configuration for the UE from the MN.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of at least one of device and methods in accordance with embodiments of the present subject matter are now described, by way of example only, and with reference to the accompanying figures, in which:

FIG. 1 illustrates an environment for performing lower Layer (L1/L2 layers) Triggered Mobility (LTM) coordination in dual connectivity, in accordance with an embodiment of the present disclosure;

FIG. 2 illustrates a detailed diagram of a master node for performing lower Layer (L1/L2 layers) Triggered Mobility (LTM) coordination in dual connectivity, in accordance with an embodiment of the present disclosure;

FIG. 3 illustrates a detailed diagram of a secondary node for performing lower Layer (L1/L2 layers) Triggered Mobility (LTM) coordination in dual connectivity, in accordance with an embodiment of the present disclosure;

FIG. 4A shows an exemplary illustration for performing lower Layer (L1/L2 layers) Triggered Mobility (LTM) coordination in dual connectivity, in accordance with some embodiments of the present disclosure;

FIG. 4B shows an exemplary illustration for performing lower Layer (L1/L2 layers) Triggered Mobility (LTM) coordination in dual connectivity, in accordance with some embodiments of the present disclosure;

FIG. 4C shows an exemplary illustration for performing lower Layer (L1/L2 layers) Triggered Mobility (LTM) coordination in dual connectivity, in accordance with some embodiments of the present disclosure;

FIG. 5 shows an exemplary flow chart illustrating method steps of a master node for performing lower Layer (L1/L2 layers) Triggered Mobility (LTM) coordination in dual connectivity, in accordance with some embodiments of the present disclosure;

FIG. 6 shows an exemplary flow chart illustrating method steps of a secondary node for performing lower Layer (L1/L2 layers) Triggered Mobility (LTM) coordination in dual connectivity, in accordance with some embodiments of the present disclosure; and

FIG. 7 shows a block diagram of a general-purpose computing system for performing lower Layer (L1/L2 layers) Triggered Mobility (LTM) coordination in dual connectivity, in accordance with embodiments of the present disclosure.

FIG. 8 is a block diagram illustrating a structure of a user equipment (UE or terminal) according to embodiments of the present disclosure; and

FIG. 9 is a block diagram illustrating a structure of a base station (BS) according to embodiments of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### BEST MODE FOR CARRYING OUT THE INVENTION

In wireless communication, a User Equipment (UE) moves across various cells. In the process of moving the UE from a source cell to a target cell, mobility is performed using a procedure called cell reselection. Conventionally, the mobility is performed using a procedure called handover in RRC_CONNECTED mode. The mobility is triggered using a RRC message and a Network controlled mobility is applied to the UE in the RRC_CONNECTED mode. In the RRC_CONNECTED mode, an explicit RRC signalling (RRC message) is required to trigger a Next Generation Node B (gNB) in New Radio (NR). Handover in NR is performed using three steps such as, handover preparation, handover execution and handover completion. The gNB may configure the UE to report measurements and based on the reported measurements or based on its own understanding of the network topology, the gNB will send RRC Reconfiguration message to handover the UE to the target cell from the source cell. The UE accesses the target cell and sends RRC Reconfiguration complete message to the source cell.

In an alternative way, the gNB may configure the UE with execution conditions for triggering handover and once the execution conditions are satisfied, the UE may move to target cell and sends the RRC Reconfiguration complete. However, in the conventional methods, the UE performs handover by sending layer 3 (RRC) messages which causes considerable signalling overhead and latency issues. Hence, there is a requirement to reduce the occurrence of signalling overhand and latency issues during handover of the UE from the source cell to target cell. 3GPP release 18 considers lower layers (L1/L2 layers) triggered mobility, also known as LTM to solve this problem.

The information disclosed in this background of the disclosure section is only for enhancement of understanding of the general background of the invention and should not be taken as an acknowledgement or any form of suggestion that this information forms the prior art already known to a person skilled in the art.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

### MODE FOR THE INVENTION

For the purpose of present disclosure, the relevant 3GPP specifications such as TS38.300, TS38.331, TS 38.321, TS 37.340 may be considered as prior arts. As per 3GPP, the goal of LTM is to enable a serving cell change via L1/L2 signalling, in order to reduce the latency, overhead and interruption time. Network gNB may configure the UE with multiple candidate cells to allow fast application of configurations for candidate cells. Network may further send MAC CE or L1 signalling to dynamically switch the UE from a source cell to one of the configured candidate cells. Further, LTM can be triggered based on L1 measurements rather than L3 measurements.

GPP proposes to perform LTM, without reset of lower layers like MAC to avoid data loss and to reduce the additional delay of data recovery wherever it is possible. The gNB may provide LTMCandidateConfiguration i.e., configure LTM candidate cells through one RRCReconfiguration message for a candidate target cell or through one CellGroupConfig for each candidate target cell or through any similar RRC structure or information element (IE) containing the similar fields (for e.g., a new IE LTM-CandidateConfig can be defined as ASN.1 sequence containing cellgroupconfig and some other information elements in the RRCReconfiguration). The gNB may further release or modify the candidate configurations. A UE may store the LTM configuration of other candidate cells even after moving to a candidate cell through LTM.

To avoid transmitting a large message over air interface, the gNB can provide the LTMCandidateConfiguration as delta configuration instead of full configuration. The gNB can indicate the UE to use the source cell configuration as the reference for delta configuration or provide the reference configuration explicitly.

The gNB may provide LTMCandidateConfiguration, i.e. configure LTM candidate cells through one RRCReconfiguration message for a candidate target cell or through one CellGroupConfig for each candidate target cell or through any similar RRC structure or IE containing the similar fields (for e.g. a new IE LTM-CandidateConfig can be defined as ASN.1 sequence containing CellGroupConfig and some other information elements in the RRCReconfiguration). The gNB may further release or modify the candidate configurations. A UE may store the LTM configuration of other candidate cells even after moving to a candidate cell through LTM. The gNB also may provide the UE with configuration for performing LTM measurements (L1 measurements which are performed by the UE for LTM are called LTM measurements) for different candidate frequencies and candidate cells and reporting based on the performed LTM measurements.

The gNB provides reference configuration, L1 measurement configuration and candidate cell configuration in a RRC ASN.1 SEQUENCE used for LTM Configuration. An example sequence is given as below.

ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-Ies, |
| criticalExtensionsFuture | SEQUENCE { |

}
}

| RRCReconfiguration-Ies ::= | SEQUENCE { | |
|---|---|---|
| radioBearerConfig | RadioBearerConfig | OPTIONAL, -- Need M |
| secondaryCellGroup | OCTET STRING CONTAINING CellGroupConfig) | OPTIONAL, -- Cond SCG |
| measConfig | MeasConfig | OPTIONAL, -- Need M |
| lateNonCriticalExtension | OCTET STRING | OPTIONAL, |
| nonCriticalExtension | RRCRcconfiguration-v1530-Ics | OPTIONAL |

}

| RRCReconfiguration-v1530-Ies ::= | SEQUENCE { | |
|---|---|---|
| masterCellGroup | OCTET STRING (CONTAINING CellGroupConfig) | OPTIONAL, -- Need M |
| fullConfig | ENUMERATED {true} | OPTIONAL, -- Cond FullConfig |
| dedicatedNAS-MessageList | SEQUENCE (SIZE(1..maxDRB)) OF DedicatedNAS-Message | OPTIONAL, -- Cond |

nonHO

| | | |
|---|---|---|
| masterKeyUpdate | MasterKeyUpdate | OPTIONAL, -- Cond MasterKeyChange |
| dedicatedSIB1-Delivery | OCTET STRING (CONTAINING SIB1) | OPTIONAL, -- Need N |
| dedicatedSystemInformationDelivery | OCTET STRING (CONTAINING SystemInformation) | OPTIONAL, -- Need N |
| otherConfig | OtherConfig | OPTIONAL, -- Need M |
| nonCriticalExtension | RRCReconfiguration-v1540-Ies | OPTIONAL |

}

| RRCReconfiguration-v1540-Ies ::= | SEQUENCE { | |
|---|---|---|
| otherConfig-v1540 | OtherConfig-v1540 | OPTIONAL, -- Need M |
| nonCriticalExtension | RRCReconfiguration-v1560-Ies | OPTIONAL |

}

| RRCReconfiguration-v1560-Ies ::= | SEQUENCE { | |
|---|---|---|
| mrdc-SecondaryCellGroupConfig | SetupRelease { MRDC-SecondaryCellGroupConfig } | OPTIONAL, -- Need M |
| radioBearerConfig2 | OCTET STRING (CONTAINING RadioBearerConfig) | OPTIONAL, -- Need M |
| sk-Counter | SK-Counter | OPTIONAL, -- Need N |
| nonCriticalExtension | RRCReconfiguration-v1610-Ies | OPTIONAL |

}

| RRCReconfiguration-v1610-Ies ::= | SEQUENCE { | |
|---|---|---|
| otherConfig-v1610 | OtherConfig-v1610 | OPTIONAL, -- Need M |
| bap-Config-r16 | SetupRelease { BAP-Config-r16 } | OPTIONAL, -- Need M |
| iab-IP-AddressConfigurationList-r16 | IAB-IP-AddressConfigurationList-r16 | OPTIONAL, -- Need M |
| conditionalReconfiguration-r16 | ConditionalReconfiguration-r16 | OPTIONAL, -- Need M |
| daps-SourceRelease-r16 | ENUMERATED {true} | OPTIONAL, -- Need N |
| t316-r16 | SetupRelease {T316-r16} | OPTIONAL, -- Need M |
| needForGapsConfigNR-r16 | SetupRelease {NeedForGapsConfigNR-r16} | OPTIONAL, -- Need M |
| onDemandSIB-Request-r16 | SetupRelease { OnDemandSIB-Request-r16 } | OPTIONAL, -- Need M |
| dedicatedPosSysInfoDelivery-r16 | OCTET STRING (CONTAINING PosSystemInformation-r16-Ies) | OPTIONAL, -- Need N |
| sl-ConfigDedicatedNR-r16 | SetupRelease {SL-ConfigDedicatedNR-r16} | OPTIONAL, -- Need M |
| sl-ConfigDedicatedEUTRA-Info-r16 | SetupRelease {SL-ConfigDedicatedEUTRA-Info-r16} | OPTIONAL, -- Need M |
| targetCellSMTC-SCG-r16 | SSB-MTC | OPTIONAL, -- Need S |
| nonCriticalExtension | RRCReconfiguration-v1700-Ies | OPTIONAL |

}

| RRCReconfiguration-v1700-Ies ::= | SEQUENCE { | |
|---|---|---|
| otherConfig-v1700 | OtherConfig-v1700 | OPTIONAL, -- Need M |
| sl-L2RelayUE-Config-r17 | SetupRelease { SL-L2RelayUE-Config-r17 } | OPTIONAL, -- Need M |
| sl-L2RemoteUE-Config-r17 | SetupRelease { SL-L2RemoteUE-Config-r17 } | OPTIONAL, -- Need M |
| dedicatedPagingDelivery-r17 | OCTET STRING (CONTAINING Paging) | OPTIONAL, -- Cond PagingRelay |
| needForGapNCSG-ConfigNR-r17 | SetupRelease {NeedForGapNCSG-ConfigNR-r17} | OPTIONAL, -- Need M |
| needForGapNCSG-ConfigEUTRA-r17 | SetupRelease {NeedForGapNCSG-ConfigEUTRA-r17} | OPTIONAL, -- Need M |
| musim-GapConfig-r17 | SetupRelease {MUSIM-GapConfig-r17} | OPTIONAL, -- Need M |
| ul-GapFR2-Config-r17 | SetupRelease { UL-GapFR2-Config-r17 } | OPTIONAL, -- Need M |
| scg-State-r17 | ENUMERATED { deactivated } | OPTIONAL, -- Need N |
| appLayerMeasConfig-r17 | AppLayerMeasConfig-r17 | OPTIONAL, -- Need M |
| ue-TxTEG-RequestUL-TDOA-Config-r17 | SetupRelease (UE-TxTEG-RequestUL-TDOA-Config-r17) | OPTIONAL, -- Need M |

| | | |
|---|---|---|
| nonCriticalExtension | RRCReconfiguration-v18xy | OPTIONAL |

}

| RRCReconfiguration-v18xy-Ies ::= | SEQUENCE { | |
|---|---|---|
| ltm-CandidateConfig-r18 | SetupRelease {LTM-CandidateConfig-r18} | OPTIONAL, -- Need M |
| nonCriticalExtension | SEQUENCE { } | OPTIONAL |

}
Radio resource control information elements
LTM-CandidateConfig
The IE LTM-CandidateConfig is used to provide LTM candidate cell configuration.

LTM-CandidateConfig information element

-- ASN1START
-- TAG-LTM-CANDIDATECONFIG-START

| LTM-CandidateConfig-r18 ::= | SEQUENCE { | |
|---|---|---|
| Lte-ReferenceConfiguration-r18 | OCTET STRING (CONTAINING RRCReconfiguration) | OPTIONAL, -- Need N |
| ltm-CandidateToReleaseList-r18 | LTM-CandidateToReleaseList-r18 | OPTIONAL, -- Need N |
| ltm-CandidateToAddModList-r18 | LTM-CandidateToAddModList-r18 | OPTIONAL, -- Need N |
| ltm-candidatePartial-L2reset-Sets | SEQUENCE (SIZE (1..FFS)) OF | OPTIONAL ... |
| | LTM-CandidatePartial-L2reset-Set-18 | |

}

| | |
|---|---|
| LTM-CandidateToReleaseList-r18 ::= SEQUENCE (SIZE (1..maxNrofCellsLTM-r18)) OF LTM-CandidateId-r18 | OPTIONAL, -- |

Need N
LTM-CandidateToAddModList-r18 ::= SEQUENCE (SIZE (1..maxNrofCellsLTM-r18)) OF LTM-Candidate-r18
LTM-CandidatePartial-L2reset-Set-18 ::= SEQUENCE (SIZE (1..FFS)) OF LTM-CandidateId-r18

| | |
|---|---|
| LTM-Candidate-r18 ::= | SEQUENCE { |
| ltm-CandidateId-r18 | LTM-CandidateId-r18, |
| ltm-Config-r18 | OCTET STRING (CONTAINING RRCReconfiguration), |

...
}
-- TAG-LTM-CANDIDATECONFIG-STOP
-- ASN1STOP

LTM-CandidateConfig field descriptions

ltm-ReferenceConfiguration
This field includes an RRCReconfiguration message used to configure a reference
configuration for LTM.
ltm-Config
This field includes an RRCReconfiguration message used to configure an LTM candidate
cell. This field can include only the CellGroupConfig IE, RadioBearerConfig IE, and
MeasConfig IE.
ltm-candidatePartial-L2reset-Sets
This field indicates the sets of candidate cells in which full L2 reset is not performed
upon LTM cell switch.

UE reports LTM measurements to the source gNB, (Distributed Unit, DU of source gNB) and the source gNB will send a Downlink MAC CE such as cell switch command. Upon receiving cell switch command, UE moves to the target cell which could be in the same gNB DU or a different gNB DU.

### Dual Connectivity

Dual connectivity or more technically “multi-radio dual connectivity” is specified by 3GPP in specifications such as TS 37.340. A summary of the details on dual connectivity and measurement gap operations with dual connectivity are given below.

NG-RAN supports Multi-Radio Dual Connectivity (MR-DC) operation whereby a UE in RRC_CONNECTED is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node acts as the master node (MN) and the other as the secondary node (SN). The MN and SN are connected via a network interface and at least the MN is connected to the core network. NG-RAN supports NG-RAN E-UTRA-NR Dual Connectivity (NGEN-DC), in which a UE is connected to one NG-eNB (a E-UTRA base station that can connect to 5G core) that acts as a MN and one gNB (5G base station) that acts as a SN. NG-RAN also supports NR-E-UTRA Dual Connectivity (NE-DC), in which a UE is connected to one gNB that acts as a MN and one NG-eNB that acts as a SN.

### PSCell Change and PSCell Addition

PSCell change can occur due to mobility and may or may not be associated with the Secondary Node Change (SN change). The Secondary Node Change procedure is initiated either by MN or SN and used to transfer a UEontext from a source SN to a target SN and to change the Secondary Cell Group (SCGO configuration in UE from one SN to another.

A Conditional PSCell Change (CPC) is defined as a PSCell change that is executed by the UE when execution condition(s) is met. UE may be configured with execution condition and the RRC message like RRC Reconfiguration for executing when the conditions are met for one or more of candidate cells. The UE starts evaluating the execution condition(s) upon receiving the CPC configuration and stops evaluating the execution condition(s) once PSCell change is triggered. Intra-SN CPC without MN involvement, inter-SN CPC initiated either by MN or SN are supported.

The following principles apply to CPC:
The CPC configuration contains the configuration of CPC candidate PSCell(s) and execution condition(s) and may contain the MN configuration for inter-SN CPC.

An execution condition may consist of one or two trigger condition(s) (CPC events A3/A5, as defined in TS 38.331). Only single RS type is supported and at most two different trigger quantities (e.g. RSRP and RSRQ, RSRP and SINR, etc.) can be configured simultaneously for the evaluation of CPC execution condition of a single candidate PSCell.

Before any CPC execution condition is satisfied, upon reception of PSCell change command or PCell change command, the UE executes the PSCell change procedure as described in clause 10.3 and 10.5 or the PCell change procedure as described in clause 9.2.3.2 in TS 38.300 [3] or clause 10.1.2.1 in TS 36.300 [2], regardless of any previously received CPC configuration. Upon the successful completion of PSCell change procedure or PCell change procedure, the UE releases all stored CPC configurations.

While executing CPC, the UE is not required to continue evaluating the execution condition of other candidate PSCell(s).

Once the CPC procedure is executed successfully, the UE releases all stored CPC configurations.

Upon the release of SCG, the UE releases the stored CPC configurations.

3GPP release 18 enhances the CPC through selective activation of cellgroups where the UE doesn't release the stored CPC configuration for one or more candidate PSCells and the source PSCell based on network's inputs.

MN adds PSCell during a PSCell addition procedure. A PSCell addition procedure that is executed only when PSCell addition condition(s) are met is called Conditional PSCell Addition (CPA). It may be noted that the 3GPP specification such as TS 37.340, TS 38.331, TS 38.300 may serve as prior arts for the present disclosure.

For a UE in dual connectivity, both MN and SN can provide the LTM configuration including LTM candidate cells and LTM reference configuration. MN and SN may also provide the LTM measurement configurations to the UE.

### Measurements in Dual Connectivity

The measurements in dual connectivity are described based on the 3GPP specification TS 37.340, V17.2.0.

Measurements can be configured independently by the MN and by the SN (intra-RAT measurements on serving and non-serving frequencies). The MN indicates the maximum number of frequency layers and measurement identities of intra-frequency and inter-frequency measurement that can be used in the SN to ensure that UE capabilities are not exceeded. In MR-DC, to assist MN to identify the measurement type, the SN indicates to the MN the list of SCG serving frequencies. In NR-DC, to assist SN to identify the measurement type, the MN indicates also to SN the list of MCG serving frequencies. The SN can also request the MN for new maximum values of the number of measurement identities that it can configure, and it is up to the MN whether to accommodate the SN request, based on the capability coordination principles as described in section 7.3 of TS 37.340. If the SN receives from the MN a new value for the maximum number of measurement identities, is SN responsibility to ensure that its configured measurement identities to comply with the new limit.

If the MN and SN both configure measurements on the same carrier frequency then the configurations need to be consistent (if the network wants to ensure these are considered as a single measurement layer). Each node (MN and SN) can configure independently a threshold for the SpCell quality. In (NG) EN-DC scenario, when the PCell quality is above the threshold configured by the MN, the UE is still required to perform inter-RAT measurements configured by the MN on the SN RAT (while it's not required to perform intra-RAT measurements); when the PSCell quality is above the threshold configured by the SN, the UE is not required to perform measurements configured by the SN. In NR-DC or NE-DC scenario, when the PCell quality is above the threshold configured by the MN, the UE is not required to perform measurements configured by the MN and when the PSCell quality is above the threshold configured by the SN, the UE is not required to perform measurements configured by the SN.

In MR-DC, both the MN and the SN can configure CGI reporting. The MN can configure CGI reporting for intra-RAT and inter-RAT cells, but the SN can only configure CGI reporting of intra-RAT cells. At any point in time, the UE can be configured with at most one CGI reporting configuration. For CGI reporting coordination, the SN sends the CGI measurement request and the embedded CGI reporting configuration to the MN. Optionally, the SN sends the unknown cell information to the MN. If there is no ongoing CGI reporting measurement on UE side, the MN forwards the SN CGI measurement configuration to UE. Otherwise, the MN rejects the request by sending X2/Xn reject message. In case the SN indicates the unknown cell information, and the CGI information of the requested cell is already available in the MN, the MN can also reject the request, and sends the CGI information of the requested cell to the SN. The SN cannot configure the CGI measurement using the SRB3.

Both MN-configured and SN-configured RRM measurements are supported while the SCG is deactivated. The PSCell measurement cycle when in deactivated SCG state is configured by RRC.

When the radio bearer, SRB3 is not configured or the SCG is deactivated, reports for measurements configured by the SN are sent on SRB1. When SRB3 is configured and SCG transmission of radio bearers is not suspended and the SCG is not deactivated, reports for measurements configured by the SN are sent on SRB3.

Measurement results related to the target SN can be provided by MN to target SN at MN initiated SN change procedure. Measurement results of target SN can be forwarded from source SN to target SN via MN at SN initiated SN change procedure. Measurement results related to the target SN can be provided by source MN to target MN at Inter-MN handover with/without SN change procedure.

Measurement results according to measurement configuration from the MN are encoded according to SN RRC when they are provided by MN to SN in SgNB Addition Request message/SN Addition Request message. During SN initiated SN change procedure, measurement results according to measurement configuration from SN are encoded according to SN RRC when they are provided by MN to SN in SgNB Addition Request message/SN Addition Request message.

Per-UE or per-FR measurement gaps can be configured, depending on UE capability to support independent FR measurement and network preference. Per-UE gap applies to both FR1 (E-UTRA, UTRA-FDD and NR) and FR2 (NR) frequencies. For per-FR gap, two independent gap patterns (i.e. FR1 gap and FR2 gap) are configured for FR1 and FR2 respectively. The UE may also be configured with a per-UE gap sharing configuration (applying to per-UE gap) or with two separate gap sharing configurations (applying to FR1 and FR2 measurement gaps respectively).

If per-UE gap is used, the MN decides the gap pattern and the related gap sharing configuration. If per-FR gap is used, in EN-DC and NGEN-DC, the MN decides the FR1 gap pattern and the related gap sharing configuration for FR1, while the SN decides the FR2 gap pattern and the related gap sharing configuration for FR2. In NE-DC and NR-DC, the MN decides both the FR1 and FR2 gap patterns and the related gap sharing configurations.

In EN-DC and NGEN-DC, the measurement gap configuration from the MN to the UE indicates if the configuration from the MN is a per-UE gap or an FR1 gap configuration. The MN also indicates the configured per-UE or FR1 measurement gap pattern and the gap purpose (per-UE or per-FR1) to the SN. Measurement gap configuration assistance information can be exchanged between the MN and the SN. For the case of per-UE gap, the SN indicates to the MN the list of SN configured frequencies in FR1 and FR2 measured by the UE. For the per-FR gap case, the SN indicates to the MN the list of SN configured frequencies in FR1 measured by the UE and the MN indicates to the SN the list of MN configured frequencies in FR2 measured by the UE. In NE-DC, the MN indicates the configured per-UE or FR1 measurement gap pattern to the SN. The SN can provide a gap request to the MN, without indicating any list of frequencies.

In NR-DC, the MN indicates the configured per-UE, FR1 or FR2 measurement gap pattern and the gap purpose to the SN. The SN can indicate to the MN the list of SN configured frequencies in FR1 and FR2 measured by the UE. In (NG) EN-DC and NRDC, SMTC can be used for PSCell addition/PSCell change to assist the UE in finding the SSB in the target PSCell. In case the SMTC of the target PSCell is provided by both MN and SN it is up to UE implementation which one to use. In the prior arts, the measurement gaps are used only for L3 measurements.

Internode messaging between MN and SN

In NR,SN sends Inter-Node RRC message CG-Config to MN to inform about the configurations it has used and to request about the configuration it can use. CG-Config is defined in TS 38.331 such as TS 38.331 V17.2.0.

| CG-Config ::= | SEQUENCE { |
|---|---|
| criticalExtensions | CHOICE { |
| c1 | CHOICE{ |
| cg-Config | CG-Config-IEs, |
| spare3 NULL, spare2 NULL, spare1 NULL | |
| }, | |
| criticalExtensionsFuture | SEQUENCE { } |

}
}

The MN sends Inter-Node RRC message CG-ConfigInfo to the SN to inform about the configurations it is allowed to use, as well as other informations. CG-ConfigInfo is defined in TS 38.331 such as TS 38.331 V17.2.0.

Both MN and SN may configure LTM measurements and LTM candidate cells. Hence, there exist a need for coordinating the capabilities of both MN and SN.

In one embodiment, MN-SN interaction for LTM takes place through CG-ConfigInfo. In one embodiment, MN indicates the maximum number of frequencies SN can configure the UE for LTM measurements by Using IE maxMeasFreqsSCG. In the current system, maxMeasFreqsSCG includes the maximum number of frequencies that can be configured by SN for L3 mobility. The disclosure proposes, MN to include the maximum number of frequencies configured for LTM as well as for L3 Mobility in the IE maxMeasFreqsSCG. In this way, MN informs SN the maximum number of frequencies SN can configure for L3 handover and LTM together. While configuring the measurements for LTM and L3 measurements, SN configures maxMeasFreqsSCG layers at most, including both the measurements configured for LTM and L3. In another embodiment, MN indicates to the SN, the maximum number of NR inter-frequency carriers, the SN is allowed to configure for LTM measurements. This is done using a separate RRC IE such as LTMmaxMeasFreqsSCG, which informs SN the maximum number of NR inter-frequency carriers the SN is allowed to configure with PSCell for LTM measurements, and is send by MN to SN.

In another embodiment, MN-SN interaction for LTM takes place through CG-Config. Here, SN includes the LTM measurement configurations in the CG-Config and sends to the MN. The LTM Measurement configuration sent from SN to MN includes resource configuration such as time domain information that includes SMTC information, periodicity, SSB position in burst etc. and frequency domain information such as subcarrier spacing, enter frequency. SN also sends the allowed transmission power to MN.

The MN-SN interaction for LTM through CG-ConfigInfo. The MN informs SN the maximum number of frequencies SN configures the UE for LTM measurements. In an embodiment, the MN informs the SN the above information through InterNode RRC message like CG-ConfigInfo in NR. In an embodiment, for NR, MN includes the maximum number of frequencies SN can configure the UE for LTM measurements in ConfigRestrictInfoSCG IE send by MN to SN.

In one embodiment, the MN indicates the maximum number of frequencies SN can configure the UE for LTM measurements through one of these ways:
1. Using IE maxMeasFreqsSCG. In the current NR system, maxMeasFreqsSCG includes the maximum number of frequencies that can be configured by SN for L3 mobility. The present disclosure proposes, MN to include the maximum number of frequencies configured for LTM as well as for L3 Mobility in the IE maxMeasFreqsSCG. In this way, MN informs SN the maximum number of frequencies SN can configure for L3 handover and LTM together. While configuring the measurements for LTM and L3 measurements, SN configures maxMeasFreqsSCG layers at most, including both the measurements configured for LTM and L3 mobility.
2. MN indicates to the SN, the maximum number of NR inter-frequency carriers, the SN is allowed to configure for LTM measurements. This is done using a separate NR RRC IE such as LTMmaxMeasFreqsSCG, which informs SN the maximum number of NR inter-frequency carriers the SN is allowed to configure with PSCell for LTM
measurements, and is send by MN to SN.

An example specification extract is given below:

| | |
|---|---|
| ConfigRestrictInfoSCG ::= | SEQUENCE { |

<some IEs>

| | |
|---|---|
| allowedReducedConfigForOverheating-r16 | OverheatingAssistance |

OPTIONAL,

| | |
|---|---|
| maxToffset-r16 | T-Offset-r16 |

```
OPTIONAL ]],
  [[
    allowedReducedConfigForOverheating-r17
```

| | |
|---|---|
| OverheatingAssistance-r17 | OPTIONAL, |
| maxNumberUDC-DRB-r17 | INTEGER (0..2) |

OPTIONAL,

| | |
|---|---|
| maxNumberCPCCandidates-r17 | INTEGER (0..maxNrofCondCells- |

```
1-r17)
    OPTIONAL
  ]],
[[
```

| | |
|---|---|
| LTMmaxMeasFreqsSCG | INTEGER (1..maxMeasFreqsMNLTM) |

]]
}
LTMmaxMeasFreqsSCG and maxMeasFreqsMNLTM are exemplary names.

In one embodiment, the maximum value of maxMeasFreqsMNL™ is equal to maxMeasFreqsMN. In an embodiment, the maximum value of maxMeasFreqsMNL™ is a new value which is lesser than maxMeasFreqsMN.

LTMmaxMeasFreqsSCG may be defined as follows in TS 38.331.

LTMmaxMeasFreqsSCG

Indicates the maximum number of NR inter-frequency carriers the SN is allowed to configure with PSCell for LTM measurements.

In an embodiment, the SN configures less than or equal to LTMmaxMeasFreqsSCG frequencies for LTM measurements.

In one embodiment, if the SN has a requirement to configure more than LTMmaxMeasFreqsSCG frequencies, it requests SN for a new value of LTMmaxMeasFreqsSCG. In an embodiment, the SN sends this request to MN through CG-Configmessage. MN may release some of the frequencies configured by itself for the UE for LTM measurements and further configure SN with a new value of LTMmaxMeasFreqsSCG defined above.

In one embodiment, the MN sets the value of LTMmaxMeasFreqsSCG based on the allowedBC-ListMRDC in ConfigRestrictInfoSCG. In an embodiment, the SN configures the LTM measurements as well as the LTM candidate cells based on both LTMmaxMeasFreqsSCG and maxMeasFreqsSCG and the ConfigRestrictInfoSCG.

In one embodiment, the SN informs MN the number of frequencies the UE is configured with for LTM Measurements.

In one embodiment, the SN informs MN the ARFCN (NR-ARFCN if SN is a gNB) of the frequencies the UE is configured with for LTM measurements. In NR, the SN informs MN the number of frequencies the UE is configured with for LTM measurements through INM RRC message CG-Config.

In an embodiment, the SN informs MN the ARFCN of the frequencies the UE is configured with for LTM measurements using the existing information elements in CG-Config, such as measuredFrequenciesSN. UE includes ARFCN-ValueNR of the frequencies configured for LTM and L3 measurements in the MeasConfigInfo. If the same frequency is configured for both LTM and L3 measurements they are included only once (i.e. the values are not duplicated)

An example specification extract is given below:

| | |
|---|---|
| MeasConfigSN ::= | SEQUENCE { |
| measuredFrequenciesSN | SEQUENCE (SIZE |
| (1..maxMeasFreqsSN)) OF NR-FreqInfo | OPTIONAL, |

...
}

| | |
|---|---|
| NR-FreqInfo ::= | SEQUENCE { |
| measuredFrequency | ARFCNValueNR |

OPTIONAL,
...
}

For e.g., the measuredFrequenciesSN in TS 38.331 is updated for LTM, where MeasuredFrequenciesSN is used by the SN to indicate a list of frequencies measured by the UE for LTM and L3 measurements.

In one embodiment, SN informs the frequencies the UE is configured with for LTM measurements using a new IE in CG-Config, for e.g LTMmeasuredFrequenciesSN. LTMmeasuredFrequenciesSN may be defined as below in TS 38.331.

| | |
|---|---|
| MeasConfigSN ::= | SEQUENCE { |
| measuredFrequenciesSN | SEQUENCE (SIZE |
| (1..maxMeasFreqsSN)) OF NR-FreqInfo | OPTIONAL, |
| LTMmeasuredFrequenciesSN | SEQUENCE (SIZE |
| (1..maxMeasFreqsSN)) OF NR-FreqInfo | OPTIONAL, |

...
}

The LTMmeasuredFrequenciesSN is used by SN to indicate a list of frequencies measured by the UE for LTM.

MN-SN interaction for LTM taking place through CG-Config. SN includes the LTM measurement configurations in the CG-Config and sends to the MN.

The LTM Measurement configuration sent from SN to MN includes resource configuration such as time domain information that includes SMTC information, periodicity, SSB position in burst etc. and frequency domain information such as subcarrier spacing, enter frequency. SN also sends the allowed transmission power to MN.

In one embodiment, MN uses the received information from the above embodiments for configuring measurement gaps, including the measurement gaps required for LTM measurements, the frequencies to be configured by MN for the LTM and L3 measurements.

In an embodiment, MN informs SN the frequencies configured for LTM measurements and the frequencies configured for LTM candidate cells through INM messages such as CG-ConfigInfo.

In one embodiment, SN ensures that the total number of frequencies configured for LTM measurements and L3 measurements are less than a constant. In one embodiment the constant is maxMeasFreqsSN (as defined in TS 38.331 V17.3.0, i.e., 32). If the SN has configured N frequencies for L3 measurements, the total number of new frequencies (new frequencies mean frequencies other than the frequencies for which L3 measurements are configured) that the SN will configure for LTM will be less than or equal to N−maxMeasFreqsSN.

In an embodiment, SN configures only the frequencies it has configured for L3 measurements as frequencies for LTM measurements.

In an alternate embodiment, SN ensures that the total number of frequencies are less than a constant, irrespective of the number of frequencies configured for L3 handover. For e.g. a new constant, LTMmaxMeasFreqsSN.

In one embodiment, MN ensures that the total number of frequencies configured for LTM measurements and L3 measurements are less than a constant. In one embodiment the constant is maxMeasFreqsMN (as defined in TS 38.331 V17.3.0, i.e., 32).

If the MN has configured N frequencies for L3 measurements, the total number of new frequencies (new frequencies mean frequencies other than the frequencies for which L3 measurements are configured) that the MN will configure for LTM will be less than or equal to N-maxMeasFreqsMN.

In an embodiment, MN configures only the frequencies it has configured for L3 measurements as the frequencies for LTM measurements.

In one alternate embodiment, MN ensures that total number of frequencies are less than a constant, irrespective of the number of frequencies configured for L3 handover. For e.g., LTMmaxMeasFreqsMN.

In one embodiment, in NR-NR DC or NE-DC if measurement gaps are required by the UE for any of the LTM measurements configured by SN (any of inter-frequency LTM measurements or any intra-frequency LTM measurements which need the gap), MN configures the measurement gaps. MN decides the gap patterns and gap sharing configuration. The measurement gaps configured in the previous embodiment is perUE, per-FR1 or per-FR2 gaps. MN informs the SN the gaps through RRC INM CG-ConfigInfo. While generating gaps, MN also considers the measurement gaps required by the UE for any of the LTM measurements or L3 measurements configured by MN (any of inter-frequency LTM measurements or any intra-frequency LTM measurements which need the gap) along with measurement gaps required by the UE for the LTM measurements or L3 measurements configured by SN. MN also allocates the measurement gaps required by the UE for any of the LTM measurements configured by the SN also.

In one embodiment, in EN-DC or NG-EN-DC if measurement gaps are required by the UE for any of the LTM measurements configured by SN (any of inter-frequency LTM measurements or any intra-frequency LTM measurements which need the gap) are per-UE gaps or per-FR1 gaps, MN decides the gap patterns, gap sharing configuration etc. and configures the measurement gaps. MN informs the SN the gaps through RRC INM CG-ConfigInfo. While generating gaps, MN also considers the measurement gaps required by the UE for any of the LTM measurements or L3 measurements configured by MN (any of inter-frequency LTM measurements or any intra-frequency LTM measurements which need the gap for which per-UE or per-FR1 gaps are required) along with measurement gaps required by the UE for the LTM measurements or L3 measurements configured by SN for which per-UE or per-FR1 gaps are required. If the measurement gaps required for LTM measurements are per-FR2 gaps, SN decides the gap patterns, gap sharing configuration etc. configure the measurement gaps of LTM measurements, also considering the measurement gap requirements for any of the L3 measurements configured by SN which require per-FR2 gaps. In an embodiment, MN allocates the measurement gaps for the LTM measurements configured by itself.

In one embodiment, MN and SN may not perform any scheduling during the configured measured gaps for LTM configuration. i.e. if the LTM measurements are performed in a measurement gap, scheduling restrictions apply.

In one embodiment, if MN configures L3 measurements for the same frequency for which SN has configured LTM measurements (i.e. there are some LTM candidate cells configured by SN in the same frequency), MN and SN ensures that both are consistent. MN configures at least one of the same reference signals configurations, the same measurement configuration, the same measurement gap configuration for the L3 measurements it is configuring, as configured by LTM measurements configured by SN. In an embodiment MN and SN may update the configurations (at least one of reference signals configuration, measurement configuration, measurement gap configuration) to ensure they are consistent.

In one embodiment, if MN configures LTM measurements (e.g., MN configuring LTM candidate cells) for the same frequency for which SN has configured L3 measurements, MN and SN ensures that both are consistent. MN configures at least one of the same reference signals configurations, the same measurement configuration, the same measurement gap configuration for the LTM measurements it is configuring, as configured by L3 measurements configured by SN. In an embodiment MN and SN may update the configurations (at least one of reference signals configuration, measurement configuration, measurement gap configuration) to ensure they are consistent.

In one embodiment, if SN configures L3 measurements for the same frequency for which MN has configured LTM measurements (i.e. there are some LTM candidate cells configured by SN in the same frequency), MN and SN ensures that both are consistent. SN configures at least one of the same reference signals configurations, the same measurement configuration, the same measurement gap configuration for the L3 measurements it is configuring as configured by LTM measurements configured by MN. In one embodiment MN and SN may update the configurations (at least one of reference signals configuration, measurement configuration, measurement gap configuration) to ensure they are consistent.

In one embodiment, if SN configures LTM measurements (e.g. SN configuring LTM candidate cells) for the same frequency for which MN has configured L3 measurements (i.e. there are some LTM candidate cells configured by SN in the same frequency), MN and SN ensures that both are consistent. SN configures at least one of the same reference signals configurations, the same measurement configuration, the same measurement gap configuration for the LTM measurements it is configuring, as configured by L3 measurements configured by MN. In one embodiment MN and SN may update the configurations (at least one of reference signals configuration, measurement configuration, measurement gap configuration) to ensure they are consistent. In one embodiment, if MN configures LTM measurements for the same frequency for which SN has configured LTM measurements (i.e. there are some LTM candidate cells configured by SN in the same frequency) or vice versa, MN and SN ensures that both are consistent. MN configures at least one of the same reference signals configurations, the same measurement configuration, the same measurement gap configuration for the LTM measurements it is configuring, as configured by LTM measurements configured by SN (or vice versa). In an embodiment MN and SN may update the configurations (at least one of reference signals configuration, measurement configuration, measurement gap configuration) to ensure they are consistent.

In one embodiment, MN and SN configure LTM measurements or L3 measurements consistently based on the frequency information exchanged between MN and SN in some of the previous embodiments of the present disclosure. The above embodiments help MN and SN to ensure that UE doesn't perform unnecessary measurements and there are no unnecessary measurement gaps configured.

In one embodiment. SN informs the cells configured for LTM to MN. In NR, SN informs MN the candidate cells it has configured for LTM through CG-Config. An example ASN.1 SEQUENCE with respect to TS 38.331 v17.3.0 is given below:

| | | |
|---|---|---|
| CG-Config-v1800-IEs ::= | | SEQUENCE { |
| candidateCellListLTM-118 | CandidateCellListLTM-r18 | OPTIONAL, |

}

| | | |
|---|---|---|
| CandidateCellListLTM-r18 | ::= | SEQUENCE (SIZE (1..maxFreq)) OF |

CandidateCellLTM-r18

| | |
|---|---|
| CandidateCellCPC-r18 ::= | SEQUENCE { |
| ssbFrequency-r18 | ARFCN-ValueNR, |
| candidateCellList-r18 | SEQUENCE (SIZE |

| | |
|---|---|
| (1..maxNrofLTMCells-r18)) | OF PhysCellId |
| } | |

Where, maxNrofLTMCells-r18) is the maximum number of LTM candidate cells that are configured in the UE. In one embodiment, maxNrofLTMCells-r18) is the maximum number of LTM candidate cells that are configured by SN. PhysCellId is physical cell identifier of the candidate cells.

In one embodiment, SN informs MN the LTM candidate cell configuration of the candidate cells it has configured to MN in CG-Config. In one embodiment, MN configures LTM candidates, Conditional PSCell change candidates or L3 measurements based on the received information about the candidate cells.

In one embodiment, MN informs SN the information such as the NR ARFCN and physical cell identifier of the cells in the SCG it has configured as LTM candidate cells. In an embodiment, MN informs SN the LTM measurement configuration, LTM candidate cell configuration and other information for the LTM candidate cells it has configured.

The present discloses provides a method and system for performing lower Layer (L1/L2 layers) Triggered Mobility (LTM) coordination in dual connectivity. In the present disclosure, a master node (MN) and the secondary node (SN) communicates with each other for performing LTM coordination in dual connectivity. The MN sends frequency information to secondary node (SN). The SN receives the frequency information and determines the configuration information based on the frequency information, Then, the SN transmits the configuration information to the MN. The MN determines the measurement gaps and LTM candidate cells based on the configuration information. Hence, the present disclosure synchronizes the frequencies of the MN and the frequencies configured for the SN based on the measurement gap. Hence, the present disclosure reduces the signaling overhead and latency issues.

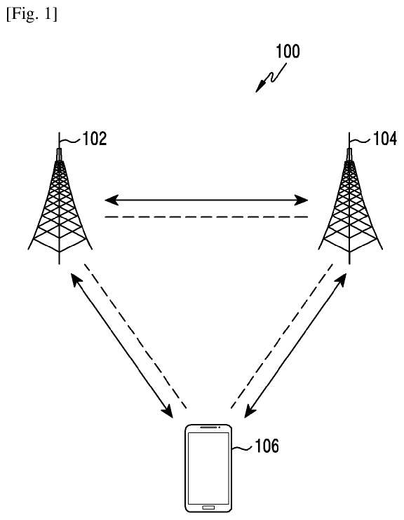

Various embodiments of the present disclosure are hereinafter explained with reference to FIGS. 1-7.

FIG. 1 illustrates an environment for performing lower Layer (L1/L2 layers) Triggered Mobility (LTM) coordination in dual connectivity, in accordance with an embodiment of the present disclosure. Environment 100 comprises a Master Node (MN) 102, a Secondary Node (SN) 104 and a User Equipment (UE) 106. In the present disclosure, the MN 102 and the SN 104 are implemented for UE 106 for performing lower Layer (L1/L2 layers) Triggered Mobility (LTM) coordination in dual connectivity. For instance, the MN 102 and the SN 104 may be network node for implementing the LTM for the UE 106. The UE 106 may be a computing system such as, a laptop computer, a desktop computer, a Personal Computer (PC), a notebook, a smartphone, a tablet, a server, a network server, a cloud-based server, and the like. The MN 102, the SN 104 and the UE 106 may communicate with each other via a cellular network or mobile network also known as radio network distributed over cellular region.

In the present disclosure, the MN 102 to which the UE 106 is connected may determine frequency information to be used by the SN 104. The frequency information comprises at least one of, but not limited to, maximum number of serving frequencies to be configured by the SN 104 for the UE 106 for LTM (such as for LTM measurements and LTM candidate cells) and L3 mobility, number of frequencies configured by the MN 102 for the UE 106, LTM measurement configuration, Secondary Cell Group (SCG) candidate cells configured by the MN 102 for the LTM, and LTM candidate cell configuration for the MN 102 configured SCG candidate cells.

The MN 102 may also determine the number of frequencies configured by the MN 102 for the UE 106. In an embodiment, the MN 102 may determine the number of frequencies configured by the MN 102 for the UE 106 based on the UE 106 capabilities. In another embodiment, the MN 102 may determine the number of frequencies configured by the MN 102 for the UE 106 by considering previous performance of the MN 102 with respect to the LTM measurement for the UE 106 and the UE 106 capabilities. The MN 102 may determine the maximum number of serving frequencies to be configured by the SN 104 for the UE 106 for LTM based on the number of frequencies configured by the MN 102 for the UE 106 and the UE 106 capabilities. The maximum number of serving frequencies to be configured for the SN 104 may be indicated in a field of IE maximum measurement frequencies Secondary cell group (SCG). The maximum number of serving frequencies to be configured by the SN 104 for the UE 106 for LTM and L3 mobility are determined using one of a maximum measurement frequencies SCG layer including both the LTM and L3 mobility, and a number of Near radio (NR) inter-frequency carriers. The MN 102 may exclusively configure the serving frequencies configured for L3 as the frequencies for LTM measurements.

Further, the MN 102 may transmit an inter node message comprising the frequency information to be used by the SN 104 for the UE 106 for LTM and L3 mobility. The frequency information transmitted from the MN 102 may comprises at least one or the maximum number of serving frequencies, the number of frequencies configured by the MN 102 for the UE 106 to the SN 104. MN may send this information to SN in an inter node message. For example, the inter node message may be a CG-ConfigInfo in NR. In addition, the frequency information may comprise at least one of, Secondary Cell Group (SCG) candidate cells configured by the MN 102 for the LTM, LTM measurements configuration and LTM candidate cell configuration for the MN 102 configured SCG candidate cells. LTM measurement configuration may include SSB configuration, CSI-RS configuration, SMTC configuration and like. In an embodiment, the MN 102 may determine the additional information based on the capabilities of the UE 106 and the number of serving frequencies configured by the MN 102 for the UE 106. In another embodiment, the MN 102 may determine the additional information based on previous additional information stored in the MN 102.

The MN 102 may receive the LTM measurement and/or the LTM candidate cell information from SN in an inter node message. Upon the MN 102 receiving the LTM measurement and/or the LTM candidate cell information, the MN 102 may determine measurement gaps and LTM candidate cell configuration for the SN (104). The MN 102 determines the measurement gaps and LTM candidate cell configuration for the UE 106 based on the configuration information of the LTM measurement and the LTM candidate cell received from the SN 104. Further, the MN 102 may verify whether the measurement gaps are compatible based on the at least one of gap patterns, gap sharing configuration between the maximum number of serving frequencies configured by the SN 104 and the number of frequencies configured by the MN 102. Then, the MN 102 may transmit the measurement gaps and the LTM candidate cell configuration to the SN 104 and the UE 106.

In another embodiment, the SN 104 may receive the inter node message from the MN 102. The SN 104 associated with the UE 106 receives the inter node message comprising frequency information to be used by the SN 104 for the UE 106 for LTM and L3 mobility. The frequency information transmitted via the from the MN 102 may comprises at least one or the maximum number of serving frequencies, the number of frequencies configured by the MN 102 for the UE 106 to the SN 104. In addition, the frequency information may comprise at least one of, Secondary Cell Group (SCG) candidate cells configured by the MN 102 for the LTM, LTM measurements configuration and LTM candidate cell configuration for the MN 102 configured SCG candidate cells.

Upon receiving the inter node message from the MN 102, the SN 104 determines configuration information. The SN 104 determines at least one of, configuration information associated with LTM measurements and LTM candidate cells based on the inter node message. The configuration information associated with LTM measurements and LTM candidate cells comprises at least one of the number of frequencies the UE 106 configures for LTM measurements configured by the SN 104, Absolute Radio Frequency Channel Number (ARFCN) for the number of frequencies the UE (106) is configures for LTM measurements, sub carrier spacing associated with the number of frequencies the UE 106 configures for LTM measurements, list of the LTM candidate cells the UE 106 configures for the candidate cells and the LTM candidate cell configuration for the candidate cells. The at least one configuration information associated with LTM measurements may be received via the CG-Config. The at least one configuration information may comprise resource configuration, frequency domain information and an allowed transmission power. For example, the resources configuration may comprise time domain information such as SS/PBCH Block Measurement Timing Configuration (SMTC) information, periodicity of the frequency signal, synchronization signal block (SSB) position in burst of the frequency signal and the like. The SMTC information may indicate a network providing a timing of a neighbor cell synchronization signal block (SSBs) using SMTC. For example, the frequency domain information may comprise subcarrier spacing, enter frequency and the like.

Upon determining the at least one configuration information by the SN 104, the SN 104 may transmit the at least one configuration information to the MN 102. Further, the SN 104 may also send allowed transmission power to the MN 102.

Upon transmitting the configuration information to the MN 102, the SN 104 may receive the measurement gaps and the LTM candidate cell configuration (for e.g. configured by MN) from the MN 102. The SN 104 stores the measurement gaps and the LTM candidate cell configuration (for e.g. configured by MN) for the UE 106. The measurement gaps may indicate a time duration or a scheduling for the UE 106 to perform any measurements on the resource configuration. Further, during the time duration of the measurement gap, the MN 102 and the SN 104 may not perform any scheduling to the UE 106, as the scheduling during the time duration of the measurement gap may interrupt the measurements performed by the UE 106 on the resource configuration resulting signaling overhead and latency issues. Thus, the MN 102 transmits the determination of measurement gaps for the UE 106 to the SN 104 for synchronizing the measurement gaps between the serving frequencies configured for the SN 104 and the serving frequencies configured for the MN 102 resulting in reducing signaling overhead and latency issues. Hence the present disclose provides an efficient signaling without any delay in the signaling for the UE 106.

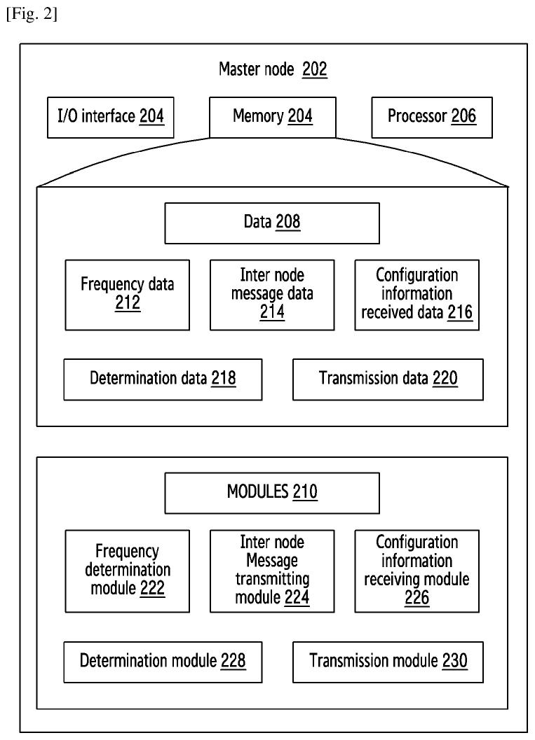

FIG. 2 illustrates a detailed diagram of a master node for performing lower Layer (L1/L2 layers) Triggered Mobility (LTM) coordination in dual connectivity, in accordance with an embodiment of the present disclosure. In an embodiment, a Master node 202 comprises an I/O interface 204, a memory 204 including one or more modules 210 and data 208, and a processor 206. The one or more modules 210 may be configured to perform the steps of the present disclosure using the data 208, to perform LTM coordination for the UE 106. In an embodiment, each of the one or more modules 210 may be a hardware unit which may be outside the memory 105 and coupled with the computing system 101. As used herein, the term modules refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 210 when configured with the described functionality defined in the present disclosure will result in a novel hardware. In one implementation, the modules 210 may include, for example, a frequency determination module 222, an inter node message transmitting module 224, a configuration information receive module 226, a determination module 228 and a transmission module 230. It will be appreciated that such aforementioned modules may be represented as a single module or a combination of different modules. In one implementation, the data 201 may include, for example, a frequency data 212, an inter node message data 214, a configuration information receive data 216, a determination data 218 and a transmission data 220.

The configuration information received data is received from the SN.

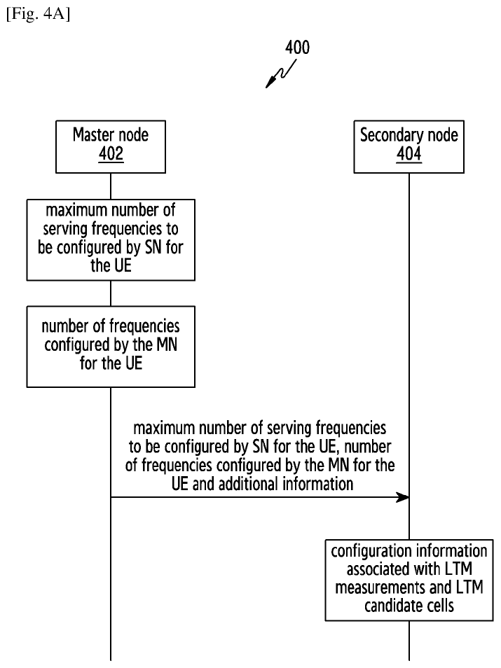

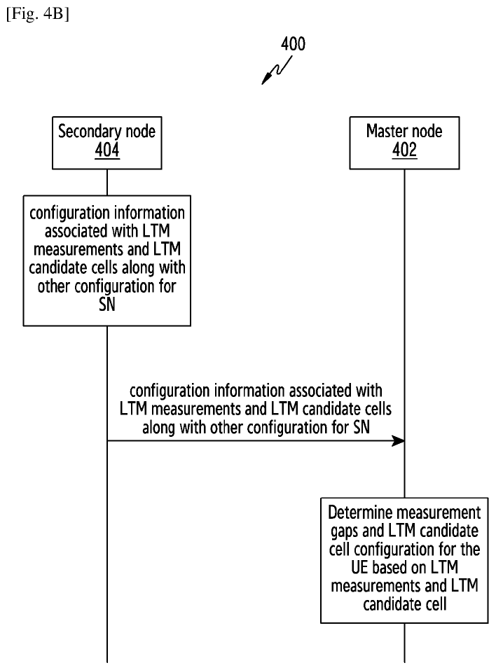

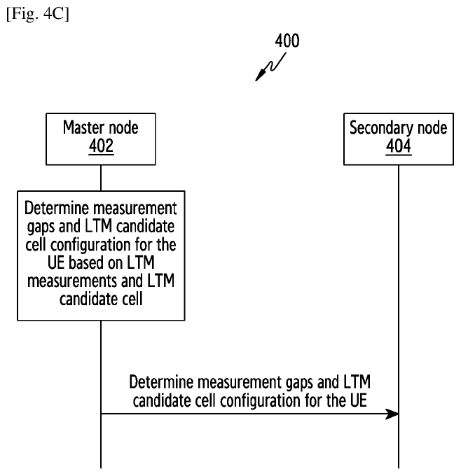

In an embodiment, the frequency determination module 222 may be configured to determine the frequency information to be used by the SN 104. The frequency data 212 may comprise frequency information to be transmitted to the SN 104. The frequency information comprises at least one of maximum number of serving frequencies to be configured by the SN 104 for the UE 106 for LTM and L3 mobility, number of frequencies configured by the MN 102 for the UE, LTM measurement configuration, Secondary Cell Group (SCG) candidate cells configured by the MN 102 for the LTM, and LTM candidate cell configuration for the MN 102 configured SCG candidate cells. The frequency determination module 222 may configure to determine the maximum number of serving frequencies to be configured by the SN 104 for the UE 106 for LTM and L3 mobility. The frequency determination module 222 may be configured to determine the number of serving frequencies to be configured by the MN 102 for the UE 106. The maximum number of serving frequencies configured by the SN 104 are based on the capabilities of the UE and the number of frequencies configured at the MN 102 for the UE. The frequency information may be stored as frequency data 212. For instance, referring to FIG. 4A, a master node MN 402 may determine the maximum number of serving frequencies configured by a secondary node (SN) 404 for the UE 106. The MN 402 determines number of serving frequencies configured by the MN 402 for the UE 106. The MN 402 determines the maximum number of serving frequencies configured by a SN 404 for the UE 106 based on the number of serving frequencies configured by the MN for the UE 106 and the capabilities of the UE.

Referring back to the FIG. 2, the inter node message transmitting module 224 may transmit the inter node message. The inter node message comprises the frequency information. The frequency information comprises at least of the maximum number of serving frequencies to be configured by the SN 104 for the UE 106 and the number of frequencies configured by the MN 102 along with the additional information to the SN 104. The inter node message may be stored as the inter node message data 214. Referring back to FIG. 4A, the master node 402 transmits an inter node message to the SN 404. The inter node message comprises optionally, the maximum number of serving frequencies configured by the SN 404 for the UE, the number of serving frequencies configured by the MN 402 for the UE 106 along with additional information. In case the SN 404 has a requirement to configure more than the maximum number of serving frequencies, the SN 404 may transmit a request for a new value of maximum number of serving frequencies upon determining that configuration required at the SN 404 for the UE 106 is more than the maximum number of serving frequencies received from the MN 402. In such case, the MN 402 may decide to release the new value based on a capability coordination technique.

In an embodiment, the configuration information receiving module 226 may receive at least one configuration information associated with LTM measurements and LTM candidate cells, configured by SN 104 for the UE 106 based on the inter node message. The configuration information may be stored as the configuration received data 216. Referring back to FIG. 4B, the SN 404 determines the configuration information based on the inter node message received from the MN 402. The configuration information associated with LTM measurements and LTM candidate cells comprises at least one of the number of frequencies the UE 106 configures for LTM measurements configured by the SN 404, Absolute Radio Frequency Channel Number (such as NR-ARFCN) for the number of frequencies the UE 106 is configures for LTM measurements, sub carrier spacing associated with the frequencies the UE 106 configured for LTM measurements, list of the LTM candidate cells the UE 106 configured for the candidate cells and the LTM candidate cell configuration for the candidate cells.

In an embodiment, the determination module 228 determines at least one of measurement gaps and LTM candidate cell configuration for the UE 106, based on at least one of the configuration information of the LTM measurement and the LTM candidate cell received from the SN 104. The measurement gaps and the LTM candidate cell configuration and the like may be stored as determination data 218. Referring back to FIG. 4B, the MN 402 determines measurement gaps and LTM candidate cell configured for the UE 106 based on the received configuration information from the SN 404.

In an embodiment, the transmission module 230 transmits the at least one of measurement gaps and LTM candidate cell configuration to the SN 104 and the UE. The transmitted measurement gaps may be stored as transmission data 220. Referring back to FIG. 4C, the MN 402 transmits the measurement gaps and the LTM candidate cell configured to the SN 404.

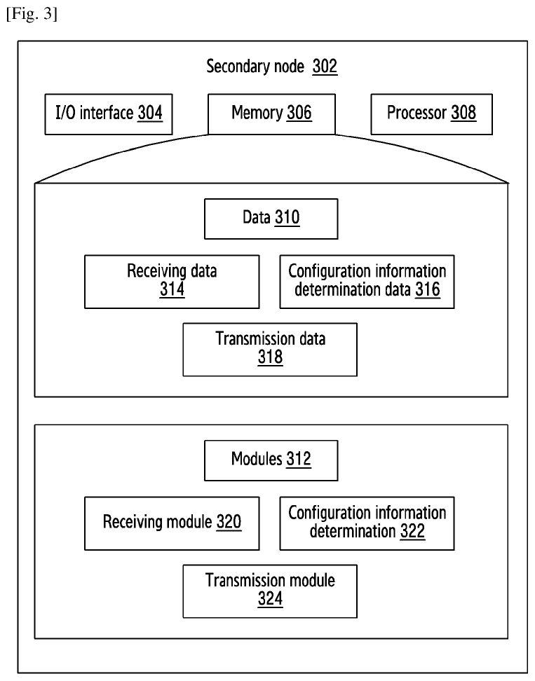

Referring to FIG. 3, In an embodiment, a Secondary node 302 comprises an I/O interface 304, a memory 306 including one or more modules 312 and data 310, and a processor 308. The one or more modules 312 may be configured to perform the steps of the present disclosure using the data 310, to perform LTM coordination for the UE 106. In an embodiment, each of the one or more modules 312 may be a hardware unit which may be outside the memory 306 and coupled with the secondary node 302. As used herein, the term modules refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 312 when configured with the described functionality defined in the present disclosure will result in a novel hardware. In one implementation, the modules 312 may include, for example, a receiving module 320, configuration information determination module 322, transmission module 324. It will be appreciated that such aforementioned modules may be represented as a single module or a combination of different modules. In one implementation, the data 201 may include, for example, a receiving data 314, configuration information determination data 316, transmission data 318.

The receiving module 320 receives an inter node message comprising frequency information to be used by the SN 104 for the UE 106 for LTM and L3 mobility, from the MN 102. The received inter node message information may be stored as receiving data 314. Referring back to FIG. 4A, the SN 404 receives an inter node messages from the MN 402. The inter node massage may comprise the frequency information to be used by the SN 404.

Referring back to FIG. 3, the configuration information determination module 322 determines at least one of configuration information associated with LTM measurements and LTM candidate cells based on the inter node message. The configuration information may be stored as configuration information determination data 316. Referring back to FIG. 4B, the SN 404 determines the configuration information based on the inter node message received from the MN 402. The configuration information associated with LTM measurements and LTM candidate cells comprises at least one of the number of frequencies the UE 106 configures for LTM measurements configured by the SN 404, Absolute Radio Frequency Channel Number (such as NR-ARFCN) for the number of frequencies the UE 106 is configured for LTM measurements by the SN (404), sub carrier spacing associated with the number of frequencies the UE 106 configures for LTM measurements by the SN (404), list of the LTM candidate cells the UE 106 configures for the candidate cells and the LTM candidate cell configuration for the candidate cells.

Referring back to FIG. 3, the transmission module 326, transmits the configuration information to the MN 102 from the SN 104. The transmitted configuration data may be stored as transmission data 318. Referring back to FIG. 4B, the SN 404 transmits the configuration information to the MN 402.

Referring back to FIG. 3, the receiving module 328 receives the measurement gaps and the LTM candidate cell configuration from the MN 102. The measurement gap information may be stored as receiving data 314. Referring back to FIG. 4C, the SN 404 receives the measurement gap and the LTM candidate cell configuration from the MN 402. Further, the SN 404 may also send the measurement gap and the LTM candidate cell configuration to the UE 106. Thus, the present disclosure synchronizes the measurement gaps between the serving frequencies configured for the SN 404 and the serving frequencies configured for the MN 402. Hence, the present disclosure reduces the signaling overhead and latency issues.

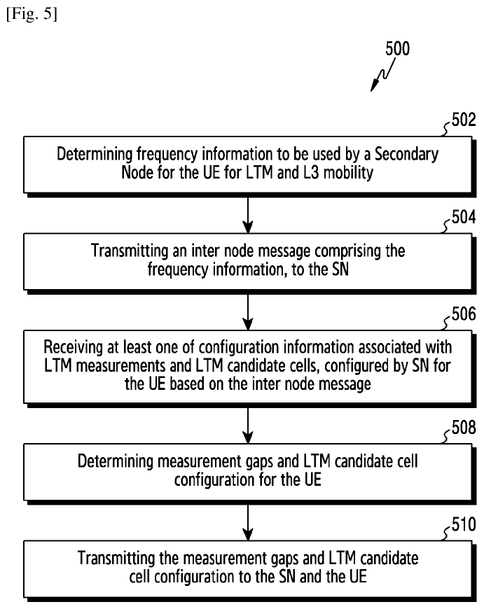

FIG. 5 shows an exemplary flow chart illustrating method steps of a master node for performing lower Layer (L1/L2 layers) Triggered Mobility (LTM) coordination in dual connectivity, in accordance with some embodiments of the present disclosure. As illustrated in FIG. 5, the method 500 may comprise one or more steps. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 502, the MN 102 associated with the UE 106 determines the maximum number of serving frequencies to be configured by the SN 104 for the UE for LTM and L3 mobility. The MN 102 determines the number of serving frequencies configured by the MN 102 for the UE 106. The maximum number of serving frequencies to be configured by the SN 104 for the UE are determined based on capabilities of the UE 106 and the number of serving frequencies configured by the MN 102 for the UE 106. The serving frequencies configured for the MN 102 for L3 measurements are configured as the frequencies for LTM measurements.

At step 504, the MN 102 transmits the inter node message comprising of the maximum number of serving frequencies to be configured by SN 104 for the UE 106 and the number of frequencies configured by the MN 102 to the SN 104. Further, the MN 102 also transmits the additional information along with serving frequencies configured by the SN 104 and the serving frequencies configured by the MN 102 for the UE 106.

At step 506, the MN 102 receives the at least one of the configuration information associated with LTM measurements and LTM candidate cells, configured by SN 104 for the UE 106 via the inter node message.

At step 508, the MN 102 determines the measurement gaps and the LTM candidate cell configuration for the UE 106 based on the configuration information of the LTM candidate cell received from the SN 104.

At step 510, the MN 102 transmits the measurement gap and the LTM candidate cell configuration to the SN 104 and the UE 106 for synchronizing the measurement gaps between the serving frequencies configured for the SN 104 and the serving frequencies configured for the MN 102. Hence, the present disclosure reduces the signaling overhead and latency issues.

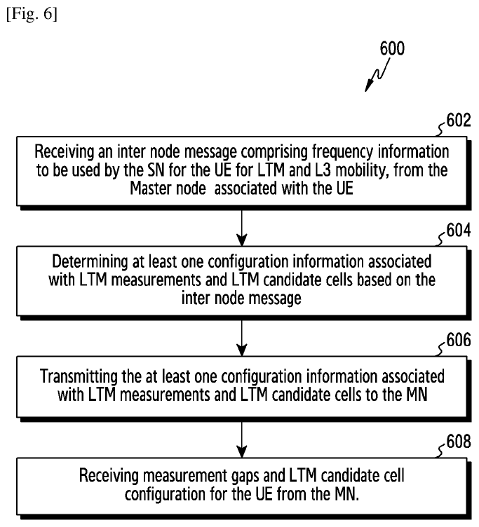

FIG. 6 shows an exemplary flow chart illustrating method steps of a secondary node for performing lower Layer (L1/L2 layers) Triggered Mobility (LTM) coordination in dual connectivity, in accordance with some embodiments of the present disclosure.

At step 602, the SN 104 associated with the UE 106 receives the inter node message comprising maximum number of serving frequencies to be configured by the SN 104 for the UE 106 for LTM and L3 mobility, from the Master node (MN) 102 associated with the UE. Further, the SN 104 may also receive additional information from the MN 102 via the inter node message. The serving frequencies configured for the SN 104 for L3 measurements are configured as the frequencies for LTM measurements.

At step 604, the SN 104 may determine the at least one configuration information associated with LTM measurements and LTM candidate cells based on the inter node message received form the MN 102.

At step 606, the SN 104 may transmit the at least one configuration information associated with LTM measurements and LTM candidate cells to the MN 102.

At step 608, the SN 104 may receive the measurement gaps and the LTM candidate cell configuration for the UE 106 from the MN 102. The SN 104 configures the measurement gap for the number of serving frequencies configured by the SN 104 for the UE. Hence, the measurement gap configured for the serving frequencies of the SN 104 are in sync with the measurement gap configured for the serving frequencies of the MN 102. The SN 104 may indicate the measurement gap for the serving frequencies to the UE.

The sequence of operations of the method 400 and the method 500 need not be necessarily executed in the same order as they are presented. Further, one or more operations may be grouped together and performed in form of a single step, or one operation may have several sub-steps that may be performed in parallel or in sequential manner.

The disclosed method with reference to FIG. 2 and FIG. 3, or one or more operations of the method 500 and 600 with reference to FIG. 5 and FIG. 6 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

### Computer System

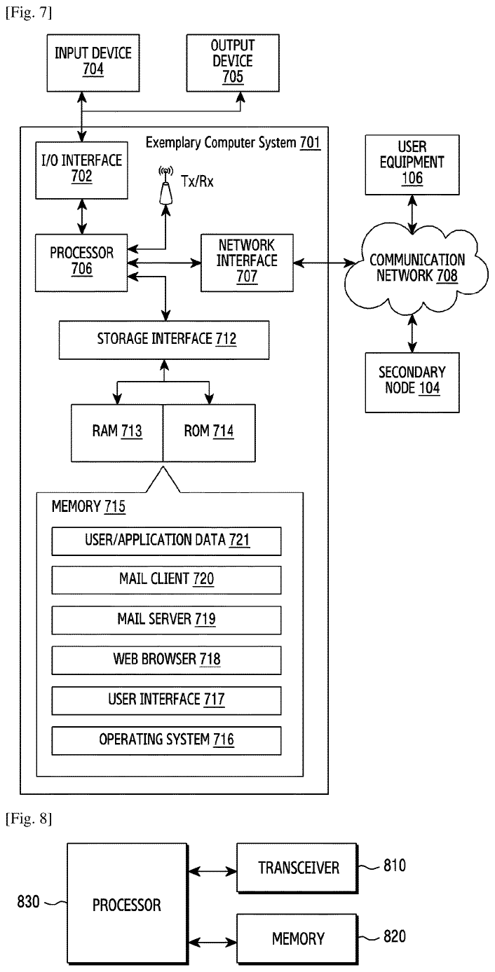

FIG. 7 illustrates a block diagram of an exemplary computer system 701 for implementing embodiments consistent with the present disclosure. In an embodiment, the exemplary computer system 701 may be the master node 102. Thus, the exemplary computer system 701 may be used to communicate with the secondary node 104. The exemplary computer system 701 may comprise a Central Processing Unit (also referred as “CPU” or “processor”). The processor 706 may comprise at least one data processor. The processor 706 may include specialized processing units such as integrated system (bus) controllers, memory management control units, floating point units, graphics processing units, digital signal processing units, etc.

The processor 706 may be disposed in communication with one or more input/output (I/O) devices (not shown) via I/O interface 702. The I/O interface 702 may employ communication protocols/methods such as, without limitation, audio, analog, digital, monoaural, RCA, stereo, IEEE (Institute of Electrical and Electronics Engineers)—1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 702, the exemplary computer system 701 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 705 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 706 may be disposed in communication with the communication network 708 via a network interface 707. The network interface 707 may communicate with the communication network 708. The network interface 707 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 708 may include, without limitation, a direct interconnection, local area network (LAN), wide area network (WAN), wireless network (e.g., using Wireless Application Protocol), the Internet, etc. The network interface 707 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 708 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc. The master node 102 may receive data (the training input data and the plurality of classes) from the neural network, over the communication network 708.

In some embodiments, the processor 706 may be disposed in communication with a memory 715 (e.g., RAM 713, ROM 714, etc.) via a storage interface 712. The storage interface 712 may connect to memory 715 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 715 may store a collection of program or database components, including, without limitation, user interface 717, an operating system 716, web browser 718 etc. In some embodiments, exemplary computer system 701 may store user/application data 721, such as, the data, variables, records, etc., as described in this disclosure. Such databases may be implemented as fault-tolerant, relational, scalable, secure databases such as Oracle® or Sybase®. The memory 715 may be communicatively coupled to the processor 706. The memory 715 stores instructions, executable by the one or more processors 706, which, on execution, may cause the processor 706 to adapt the neural networks to the data drifts.

The operating system 716 may facilitate resource management and operation of the exemplary computer system 701. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSDI®, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the exemplary computer system 701 may implement the web browser 718 stored program component. The web browser 718 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 718 may utilize facilities such as AJAX™, DHTML™, ADOBE® FLASH™, JAVASCRIPT™, JAVA™, Application Programming Interfaces (APIs), etc. In some embodiments, the exemplary computer system 501 may implement a mail server 719 stored program component. The mail server 719 may be an Internet mail server 719 such as Microsoft Exchange, or the like. The mail server 719 may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 501 may implement a mail client 720 stored program component. The mail client (720) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor 706 may be stored. Thus, a computer-readable storage medium may store instructions for execution by one or more processors 706, including instructions for causing the processor(s) 506 to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives,

Compact Disc Read-Only Memory (CD ROMs), Digital Video Disc (DVDs), flash drives, disks, and any other known physical storage media.

FIG. 8 is a block diagram illustrating a structure of a UE according to an embodiment of the disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE 106 of FIG. 1 or FIG. 7.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for upconverting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

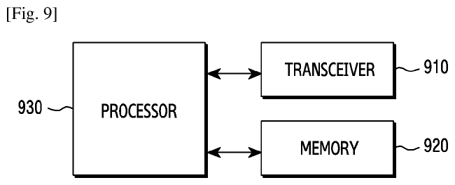

FIG. 9 is a block diagram illustrating a structure of a base station according to an embodiment of the disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station of FIG. 9 corresponds to the BS 102 or BS 104 of FIG. 1, Master nodes or Secondary nodes of FIG. 2-7.

The transceiver 910 collectively refers to a base station receiver and a base station transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CDROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The present disclosure discloses a method for performing LTM coordination in dual connectivity. The present disclosure determines the measurement gaps in the frequencies configured for the MN and the SN. Then, the measurement gaps are synchronized to reduce the signaling overhead and latency issues.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 and FIG. 6 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMS, PROMs, RAMs, DRAMs, SRAMs, Flash Memory, firmware, programmable logic, etc.), etc. Further, nontransitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing embodiments consistent with the present disclosure. A computer readable storage medium refers to any type of physical memory on which information or data readable by a processor may be stored. Thus, a computer readable storage medium may store instructions for execution by one or more processors, including instructions for causing the processor(s) to perform steps or stages consistent with the embodiments described herein. The term “computer readable medium” should be understood to include tangible items and exclude carrier waves and transient signals, i.e., are nontransitory. Examples include random access memory (RAM), read-only memory (ROM), volatile memory, non-volatile memory, hard drives, CD ROMs, DVDs, flash drives, disks, and any other known physical storage media.

Finally, the language used in the specification has been principally selected for readability and instructional purposes, and it may not have been selected to delineate or circumscribe the inventive subject matter. Accordingly, the disclosure of the embodiments of the disclosure is intended to be illustrative, but not limiting, of the scope of the disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

1. A method performed by a Master Node (MN) (102) for lower Layer (L1/L2 layers) Triggered Mobility (LTM) coordination in dual connectivity, the method comprising:
determining associated with a terminal (106), frequency information to be used by a Secondary Node (SN) (104) for the terminal (106) for LTM and L3 mobility;
transmitting an inter node message comprising the frequency information, to the SN (104);
receiving at least one of configuration information associated with LTM measurements and LTM candidate cells, configured by SN (104) for the terminal (106) based on the inter node message;
determining at least one of measurement gaps and LTM candidate cell configuration for the terminal (106), based on at least one of the configuration information of the LTM measurement and the LTM candidate cell received from the SN (104); and
transmitting the at least one of measurement gaps and LTM candidate cell configuration to the SN (104) and the terminal (106).

2. The method of claim 1, wherein the frequency information comprises at least one of maximum number of serving frequencies to be configured by SN (104) for LTM, number of frequencies configured by MN (102), LTM measurement configuration, Secondary Cell Group (SCG) candidate cells configured by the MN (102) for the LTM, and LTM candidate cell configuration for the MN (102) configured SCG candidate cells.

3. The method of claim 1, wherein the configuration information associated with LTM measurements and LTM candidate cells comprises at least one of the number of frequencies the terminal (106) configures for LTM measurements by the SN (104), Absolute Radio Frequency Channel Number (ARFCN) for the number of frequencies the terminal (106) configures for LTM measurements by the SN (104), sub carrier spacing associated with the frequencies the terminal (106) configures for LTM measurements by SN (104), list of the LTM candidate cells the terminal (106) configured by the SN (104) and the LTM candidate cell configuration for the candidate cells.

4. The method of claim 1, wherein the maximum number of serving frequencies to be configured by a Secondary Node (SN) (104) for the terminal (106) for LTM measurements and L3 mobility are determined using one of a maximum measurement frequencies SCG layer including both the LTM measurements and L3 mobility and a number of new radio (NR) inter-frequency carriers.

5. The method of claim 1, wherein MN (102) exclusively configures the serving frequencies configured for the MN (102) for L3 measurements as the frequencies for LTM measurements.

6. A master node for performing lower Layer (L1/L2 layers) Triggered Mobility (LTM) coordination in dual connectivity, the master node comprises:
a transceiver; and
a controller coupled with the transceiver and configured to: determine frequency information to be used by a Secondary Node (SN) (104) for the terminal (106) for LTM and L3 mobility;
transmit an inter node message comprising the frequency information to the SN (104);
receive at least one configuration information associated with LTM measurements and LTM candidate cells, configured by SN (104) for the terminal (106) based on the inter node message;
determine measurement gaps and LTM candidate cell configuration for the terminal (106), based on the at least one of the configuration information of the LTM measurement and the LTM candidate cell received from the SN (104); and
transmit the measurement gaps and the LTM candidate cell configuration to the SN (104) and the terminal (106).

7. The master node of claim 6, wherein the frequency information comprises at least one of maximum number of serving frequencies to be configured by SN (104) for LTM, number of frequencies configured by MN (102), LTM measurement configuration, Secondary Cell Group (SCG) candidate cells configured by the MN (102) for the LTM, and LTM candidate cell configuration for the MN (102) configured SCG candidate cells.

8. The master node of claim 6, wherein the configuration information associated with LTM measurements and LTM candidate cells comprises at least one of the number of frequencies the terminal (106) configures for LTM measurements by the SN (104), Absolute Radio Frequency Channel Number (ARFCN) for the frequencies the terminal (106) is configures for LTM measurements by SN (104), sub carrier spacing associated with the number of frequencies the terminal (106) configures for LTM measurements by SN (104), list of the LTM candidate cells the terminal (106) configure by the SN (104) and the LTM candidate cell configuration for the candidate cells.

9. The master node of claim 6, wherein the transceiver determines the maximum number of serving frequencies to be configured by a Secondary Node (SN) (104) for the terminal (106) for LTM measurements and L3 mobility by using one of a maximum measurement frequencies SCG layer including both the LTM measurements and L3 mobility and a number of new radio (NR) inter-frequency carriers.

10. The master node of claim 6, wherein the transceiver exclusively configure the serving frequencies configured for the MN (102) for L3 measurements as the frequencies for LTM measurements.

11. A method performed by a Secondary Node (SN) (104) associated with a terminal (106)) for lower Layer (L1/L2 layers) Triggered Mobility (LTM) coordination in dual connectivity, the method comprising:
receiving, from the Master node (MN) (102) associated with the terminal (106),an inter node message comprising frequency information to be used by the SN (104) for the terminal (106) for LTM measurements and L3 mobility;
determining at least one configuration information associated with LTM measurements and LTM candidate cells based on the inter node message;
transmitting, to the MN (102) the at least one configuration information associated with LTM and LTM candidate cells; and
receiving, from the MN (102), measurement gaps and LTM candidate cell configuration for the terminal (106).

12. The method of claim 11, wherein the frequency information comprises at least one of maximum number of serving frequencies to be configured by SN (104) for LTM, number of frequencies configured by MN (102), LTM measurement configuration, Secondary Cell Group (SCG) candidate cells configured by the MN (102) for the LTM, and LTM candidate cell configuration for the MN (102) configured SCG candidate cells.

13. The method of claim 11, wherein the configuration information associated with LTM measurements and LTM candidate cells comprises at least one of the number of frequencies the terminal (106) configures for LTM measurements by the SN (104), Absolute Radio Frequency Channel Number (ARFCN) for the frequencies the terminal (106) is configures for LTM measurements by the SN (104), sub carrier spacing associated with the number of frequencies the terminal (106) configures for LTM measurements by the SN (104), list of the LTM candidate cells the terminal (106) configured by the SN (104) and the LTM candidate cell configuration for the candidate cells.

14. The method of claim 11, wherein the SN (104) exclusively configures the serving frequencies configured for the SN (104) for L3 measurements as the frequencies for LTM measurements.

15. A secondary node for performing lower Layer (L1/L2 layers) Triggered Mobility (LTM) coordination in dual connectivity, the secondary node comprises:
a transceiver; and
a controller coupled with the transceiver and configured to:
receive, from the MN (102), an inter node message comprising frequency information to be used by SN (104) for the terminal (106);
determine at least one of configuration information associated with LTM and LTM candidate cells based on the inter node message;
transmit, to the MN (102), at least one of, the configuration information associated with LTM measurements and LTM candidate cells; and
receive, from the MN (102), measurement gaps and LTM candidate cell configuration for the terminal (106).
